(19) United States
(12) Patent Application Publication
(10) Pub. No.: US 2002/0173178 A1
(43) Pub. Date: Nov. 21, 2002

(54) Peripheral circuit board for a liquid crystal display device and liquid crystal display device equipped therewith

(75) Inventor: Akifumi Matsunaga, Yonago (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/059,456

(22) Filed: Jan. 29, 2002

(30) Foreign Application Priority Data
May 21, 2001 (JP) 2001-151304

(51) Int. Cl. H01R 12/00

(52) U.S. Cl. 439/67

(57) ABSTRACT

A peripheral circuit board for a liquid crystal display device formed by laminating a plurality of printed boards and a liquid crystal display device equipped therewith, featuring improved reliability in the connection to the flexible circuit boards. A connection region is formed in a laminated layer structure of a plurality of printed boards having predetermined wiring patterns, the connection region being formed by the printed boards of a number of pieces smaller than that of other regions, and a plurality of terminal portions are formed on the surface of the connection region and are electrically connected to a liquid crystal display panel through a plurality of flexible circuit boards.

### BACKGROUND OF THE INVENTION

1. Field of the Invention

This invention relates to a peripheral circuit board for a liquid crystal display device formed by laminating a plurality of printed boards, and to a liquid crystal display device equipped therewith.

2. Description of the Related Art

A liquid crystal display device (LCD) having a plurality of pixel regions arranged like a matrix in a display region, controls the display by driving the liquid crystals in the pixel regions by using drive signals input from a peripheral circuit. FIG. 10 is a perspective view illustrating a conventional constitution of an active matrix LCD having a switching element for each of the pixel regions. The LCD has an LCD (liquid crystal display) panel 102. The LCD panel 102 includes a TFT substrate 104 having a plurality of gate bus lines and drain bus lines (both of which are not shown) defining pixel regions and intersecting nearly at right angles with each other, and having thin-film transistors (TFTs) that work as switching elements. A color filter (CF) substrate 106 is arranged facing the TFT substrate 104. Liquid crystals (not shown) are sealed between the TFT substrate 104 and the CF substrate 106.

A terminal portion (not shown) of the TFT substrate 104 to which the gate bus lines and drain bus lines are connected, is connected to peripheral circuit boards 110, 111 for the LCD via a plurality of flexible circuit boards 108, 109 such as TCP (tape carrier package) and COF (chip on film). A peripheral circuit for the LCD is constituted by the flexible circuit boards 108, 109 and the peripheral circuit boards 110, 111 for the LCD. The peripheral circuit board 111 for the LCD for driving the gate bus lines, is a multi-layer printed board formed by laminating, for example, two pieces of printed boards. The peripheral circuit board 110 for the LCD for driving the drain bus lines, is a multi-layer printed board formed by laminating, for example, 6 to 8 pieces of printed boards to further increase the wiring density.

FIG. 11 is a sectional view illustrating the LCD shown in FIG. 10 along the line B-B. Referring to FIG. 11, the peripheral circuit board 110 for the LCD is formed by laminating, for example, 6 pieces of printed boards 112 having nearly the same size in cross section. Each printed board 112 has a predetermined wiring pattern 114 formed on the surface thereof. Wiring patterns 114 of different layers are electrically connected together through a hole 118 penetrating through the printed boards 112, thereby to constitute a predetermined circuit.

A terminal portion (not shown) on the surface of a connection region A of the peripheral circuit board 110 for the LCD is connected to the flexible circuit boards 108. The terminals of the two boards 110 and 108 are electrically connected together by applying, for example, an anisotropic conductive film (ACF) 116 onto the surface of the connection region A, and adhering the two boards 110 and 108 by the application of heat and pressure. When the gap between the terminals is relatively broad (e.g., not smaller than 0.4 mm), a solder is used in place of the ACF 116. The flexible circuit boards 108 are connected to the TFT substrate 104 through the terminal portion that is not shown.

FIG. 12 illustrates a step of mounting the conventional peripheral circuit board 110 for the LCD on the LCD panel 102, and is a sectional view which is the same as that as of FIG. 11. The flexible circuit boards 108 are connected to the LCD panel 102 in advance. As the LCD panel 102 and the peripheral circuit board 110 for the LCD are positioned on a jig (receiving plate) 120, the flexible circuit boards 108 and the peripheral circuit board 110 for the LCD are brought into position. A heat tool 122 is disposed over the jig 120. The heat tool 122 has a head portion 123 that works to adhere the flexible circuit boards 108 temporarily placed via the ACF 116 applied on the surface of the connection region A, onto the peripheral circuit board 110 for the LCD by the application of heat and pressure. The time for adhesion with pressure is, for example, from 15 to 20 seconds.

In the conventional LCD, the temperature on the connection surfaces of the flexible circuit boards 108 and of the peripheral circuit board 110 for the LCD rises up to about 180° C. at the time of adhesion with the application of heat and pressure. Accordingly, the peripheral circuit board 110 for the LCD undergoes the stretching or deflection due to thermal expansion. As shown in FIG. 13, the intermediate portion of the peripheral circuit board 110 for the LCD having an elongated shape undergoes the stretching as indicated by arrows a. The amount of stretching in the intermediate portion accumulates at both ends in the lengthwise direction of the peripheral circuit board 110 for the LCD. Accordingly, a relatively large stretching occurs in the lengthwise direction as indicated by arrows b. The amount of stretching occurring at both ends is, for example, about 0.2 mm per a length of, for example 35 cm. On the other hand, the flexible circuit boards 108 formed of, for example, a polyimide resin have been secured to the TFT substrate 104 and are not almost stretched despite of the thermal expansion. Accordingly, a deviation in position occurs between the terminals on the flexible circuit boards 108 and the terminals on the peripheral circuit board 110 for the LCD, arousing a problem of breakage in the connection between the terminals. Besides, since the TFT substrate 104 does not almost undergo the thermal expansion, stress due to the peripheral circuit board 110 for the LCD, that stretches, is given to the flexible circuit boards 108, causing a peeling in the portions where the flexible circuit boards 108 and the peripheral circuit board 110 for the LCD are adhered together.

The peripheral circuit board 110 for the LCD further has a predetermined wiring pattern 114 formed on the lower layer in addition to the terminal portion formed on the surface in the connection region A. Therefore, the thickness of the printed board 112 locally differs depending upon the presence of the wiring patterns 114, and the surface of the connection region A becomes rugged. Therefore, the flexible circuit boards 108 and the peripheral circuit board 110 for the LCD are not uniformly adhered together, causing the connection between the terminals to become defective.

Further, the peripheral circuit board 110 for the LCD has a thermal conductivity that differs locally depending upon the presence of the wiring pattern 114 formed by a metal layer. That is, the region where the wiring pattern 114 is formed on the lower layer has a high thermal conductivity permitting the heat to be diffused to the surrounding and is, hence, less heated. On the other hand, the region where the wiring pattern 114 is not formed on the lower layer has a low thermal conductivity permitting the heat to be less diffused to the surrounding and is, hence, easily heated. Accordingly, the temperature distribution becomes nonuniform on the surface of the connection region A accounting for the occurrence of a defective connection when the adhesion by heat and pressure is accomplished by using the ACF 116 or the solder.

### SUMMARY OF THE INVENTION

It is an object of this invention to provide a peripheral circuit board for an LCD capable of improving reliability of connection to the flexible circuit boards, and an LCD equipped with the same.

The above object is accomplished by a peripheral circuit board for a liquid crystal display device comprising a connection region formed in a laminated layer structure of a plurality of printed boards having predetermined wiring patterns, the connection region being formed by the printed boards of a number of pieces smaller than that of other regions, and a plurality of terminal portions formed on the surface of the connection region and are electrically connected to a liquid crystal display panel through a plurality of flexible circuit boards.

The above object is further accomplished by a peripheral circuit board for a liquid crystal display device comprising a connection region formed in a laminated layer structure of a plurality of printed boards having predetermined wiring patterns, the connection region being formed by the printed boards of a number of pieces smaller than that of other regions and being divided by slits into a plurality of portions in the region, and a plurality of terminal portions formed on the surface of the connection region and are electrically connected to a liquid crystal display panel through a plurality of flexible circuit boards.

Further, the above object is accomplished by a liquid crystal display device comprising a pair of boards arranged being opposed to each other, liquid crystals sealed between the pair of boards, and peripheral circuit boards for a liquid crystal display device connected to the boards via flexible circuit boards, wherein the peripheral circuit boards for the liquid crystal display device of the invention are used as the peripheral circuit boards for the liquid crystal display device.

### BRIEF DESCRIPTION OF THE DRAWINGS

FIG. 1 is a perspective view illustrating the constitutions of a peripheral circuit board for an LCD and of the LCD equipped therewith according to a first embodiment of the invention;

FIG. 2 is a sectional view illustrating the constitution of the peripheral circuit board for the LCD according to the first embodiment of the invention;

FIG. 3 is a view illustrating the constitution of the peripheral circuit board for the LCD according to the first embodiment of the invention;

FIG. 4 is a view illustrating the constitution of the peripheral circuit board for the LCD according to the first embodiment of the invention;

FIG. 5 is a sectional view illustrating a step of mounting the peripheral circuit board for the LCD according to the first embodiment of the invention;

FIG. 6 is a sectional view illustrating a modified peripheral circuit board for the LCD according to the first embodiment of the invention;

FIG. 7 is a sectional view illustrating a further modified peripheral circuit board for the LCD according to the first embodiment of the invention;

FIG. 8 is a perspective view illustrating the constitutions of the peripheral circuit board for the LCD and of the LCD equipped therewith according to a second embodiment of the invention;

FIG. 9 is a plan view illustrating the constitution of the peripheral circuit board for the LCD according to the second embodiment of the invention;

FIG. 10 is a perspective view illustrating the constitution of a conventional LCD;

FIG. 11 is a sectional view illustrating the constitution of a conventional peripheral circuit board for the LCD;

FIG. 12 is a sectional view illustrating a step of mounting the conventional peripheral circuit board for the LCD; and

FIG. 13 is a view illustrating a problem possessed by the conventional peripheral circuit board for the LCD.

### DETAILED DESCRIPTION OF THE PREFERRED EMBODIMENTS

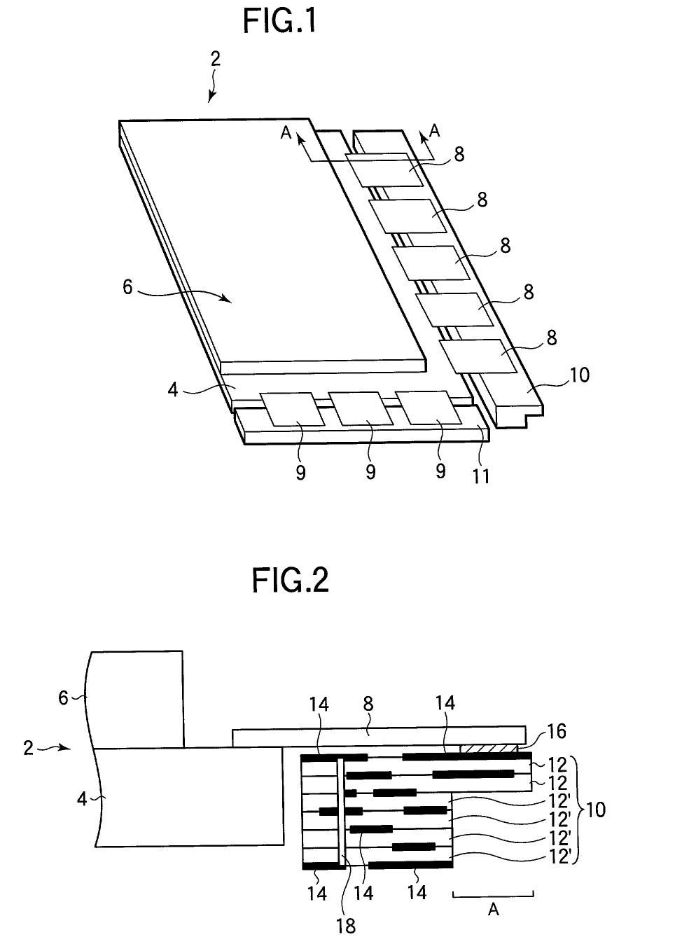

A peripheral circuit board for an LCD and the LCD equipped therewith according to a first embodiment of the invention will now be described with reference to FIGS. 1 to 7. FIG. 1 is a perspective view schematically illustrating the constitutions of the peripheral circuit board for the LCD and the LCD equipped therewith according to the embodiment. As shown in FIG. 1, the LCD has an LCD panel 2. The LCD panel 2 has a TFT substrate 4 having a plurality of gate bus lines and drain bus lines (both of which are not shown) intersecting nearly at right angles with each other, and having TFTs that work as switching elements. ACF substrate 6 is arranged facing the TFT substrate 4. Liquid crystals (not shown) are sealed between the TFT substrate 4 and the CF substrate 6.

The drain bus lines are connected to a plurality of (five in FIG. 1) flexible circuit boards 8 such as TCPs or COFs via a terminal portion that is not shown. The flexible circuit boards 8 are connected to the peripheral circuit board 10 for the LCD. The gate bus lines are connected to a plurality of (three in FIG. 1) flexible circuit board 9 via a terminal portion that is not shown. The flexible circuit boards 9 are connected to the peripheral circuit board 11 for the LCD. A peripheral circuit for the LCD is constituted by the flexible circuit boards 8, 9 and by the peripheral circuit boards 10, 11 for the LCD. The peripheral circuit boards 10, 11 for the LCD are multi-layer printed boards, the peripheral circuit board 11 for the LCD on the gate terminal side being formed by laminating, for example, two pieces of printed boards. The peripheral circuit board 10 for the LCD on the drain terminal side is formed by laminating, for example, 6 to 8 pieces of printed boards in order to more increase the wiring density than that of the peripheral circuit board 11 for the LCD on the gate terminal side.

FIG. 2 is a sectional view of the LCD cut along the line A-A in FIG. 1. Referring to FIG. 2, the peripheral circuit board 10 for the LCD is constituted by successively laminating two pieces of printed boards 12 and four pieces of printed boards 121 from the upper side. The peripheral circuit board 10 for the LCD has a connection region A connected to the flexible circuit boards 8 at an end on the side opposite to the end connected to the LCD panel 2. The printed boards 12′ have areas smaller than the areas of the printed boards 12 by the connection region A.

The peripheral circuit board 10 for the LCD has a thickness of, for example, 0.6 to 1.5 mm as a whole. The connection region A is formed by two pieces of printed boards 12, the number thereof being smaller than that of other regions, and has a thickness of, for example, from 0.2 to 0.5 mm. The printed boards 12, 12′ have predetermined wiring patterns 14 formed thereon. A through hole 18 is formed to penetrate through the printed boards 12, 12′, and the wiring patterns 14 of different layers are electrically connected together to constitute a predetermined circuit.

The terminal portion (not shown) of the TFT substrate 4 is connected to the flexible circuit boards 8. The flexible circuit boards 8 are connected to the terminal portion on the surface of the connection region A. The flexible circuit boards 8 and the terminals of the peripheral circuit board 10 for the LCD are electrically connected together by being adhered together with the application of heat and pressure with the use of, for example, an ACF 16 applied onto the surface of the connection region A.

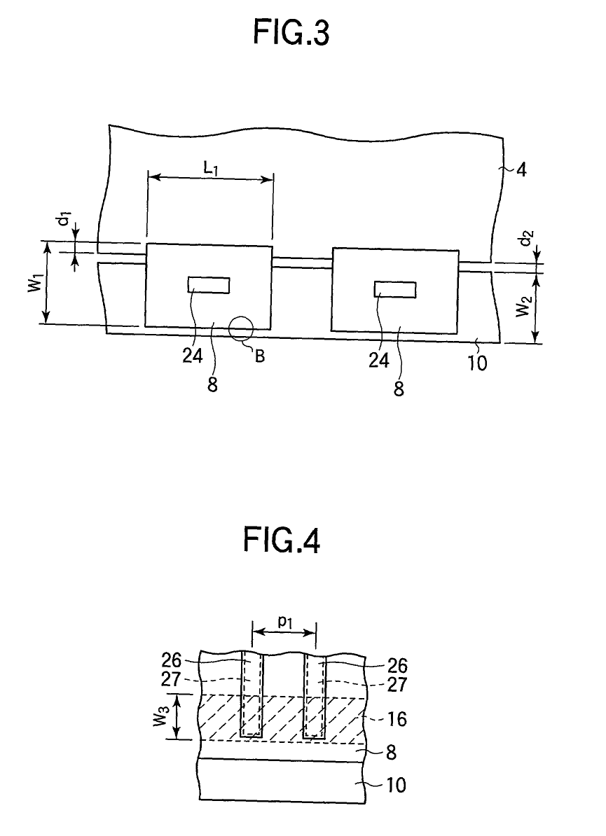

FIG. 3 is a plan view illustrating the arrangement of the peripheral circuit board 10 for the LCD, flexible circuit boards 8 and TFT board 4, and FIG. 4 illustrates, on an enlarged scale, a region B shown in FIG. 3. Referring to FIG. 3, the peripheral circuit board 10 for the LCD is formed in a rectangular shape having a width W2 (e.g., 10 to 20 mm) and a length of, for example, 35 cm.

Referring to FIG. 4, the peripheral circuit board 10 for the LCD has terminals 27 of, for example, 69 or 70 pins formed maintaining a pitch p1 (e.g., 300 to 400 μm) and a predetermined width. The terminals 27 are connected to the terminals 26 of the flexible circuit boards 8 over a width W3 (e.g., 2 mm) via the ACF 16 applied to the peripheral circuit board 10 for the LCD in the lengthwise direction thereof.

Reverting to FIG. 3, the flexible circuit boards 8 are formed in a rectangular shape maintaining a width W1 (e.g., 20 mm) and a length L1 (e.g., 30 mm). An integrated circuit (IC) 24 is mounted on the flexible circuit board 8. The integrated circuit 24 is electrically connected to the terminals formed on the flexible circuit board 8. The flexible circuit board 8 has, for example, 300 pin terminals (not shown) formed in an upper portion of the drawing maintaining a pitch of, for example, 50 to 100 μm. The terminals of the flexible circuit board 8 are connected to the terminals of the TFT board 4 over a width of, for example, 1.5 mm via the ACF applied onto the TFT board 4 in the lengthwise direction thereof. Here, the TFT substrate 4 is overlapped on the flexible circuit boards 8 over a predetermined width d1 (e.g., 1.5 mm), such that the side thereof faces the side of the peripheral circuit board 10 for the LCD maintaining a gap d2 (e.g., 1 mm).

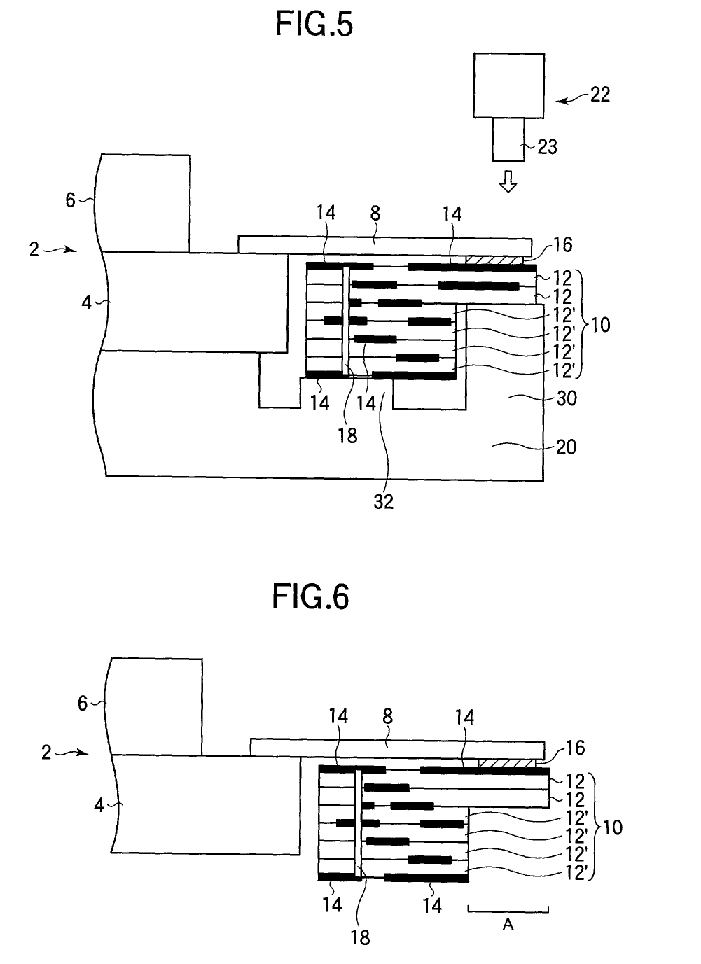

FIG. 5 illustrates a step for mounting the peripheral circuit board 10 for the LCD on the LCD panel 2 according to the embodiment, and is the same sectional view as that of FIG. 2. The flexible circuit boards 8 have been connected to the LCD panel 2 in advance. When LCD panel 2 and the peripheral circuit board 10 for the LCD are positioned on a jig 20, the flexible circuit boards 8 and the peripheral circuit board 10 for the LCD are brought into position. The jig 20 has a region 30 corresponding to the connection region A of the peripheral circuit board 10 for the LCD that is positioned, the region 30 being higher than other regions 32, so as to support the connection region A formed by the printed boards 12 of a number of pieces smaller than that of other regions of the peripheral circuit board 10 for the LCD. A heat tool 22 having a head portion 23 (e.g., 2 mm wide and 40 cm long) is disposed over the jig 20. The head portion 23 of the heat tool 22 works to adhere the flexible circuit boards 8 temporarily placed via the ACF 16 applied on the surface of the connection region A, onto the peripheral circuit board 10 by the application of heat and pressure. The time for adhesion with pressure is, for example, from 15 to 20 seconds, and the temperature on the connection surfaces is, for example, about 180° C.

The peripheral circuit board 10 for the LCD according to this embodiment has the connection region A formed by laminating the printed board 12 in a number of pieces smaller than that of other regions, the connection region A being adhered by the application of heat and pressure in a step of mounting on the LCD panel 2. Therefore, the peripheral circuit board 10 for the LCD is heated only locally at the time of adhesion with heat and pressure, heated less as a whole, and is little stretched that stems from the thermal expansion. Accordingly, the position deviates little between the peripheral circuit board 10 for the LCD and the flexible circuit boards 8 at the time of adhesion by heat and pressure, and the connection is not broken between the terminals. Besides, since no stress due to the stretching of the peripheral circuit board 10 for the LCD is added to the flexible circuit boards 8, no peeling occurs in the portions where the flexible circuit boards 8 and the peripheral circuit board 10 for the LCD are adhered together with the application of pressure. Besides, since the connection region A is formed by laminating the printed boards 12 in a number of pieces smaller than that of other regions, the surface of the connection region A becomes less rugged. Accordingly, the peripheral circuit board 10 for the LCD and the flexible circuit boards 8 are uniformly adhered together by the application of heat and pressure, without causing the connection to become defective.

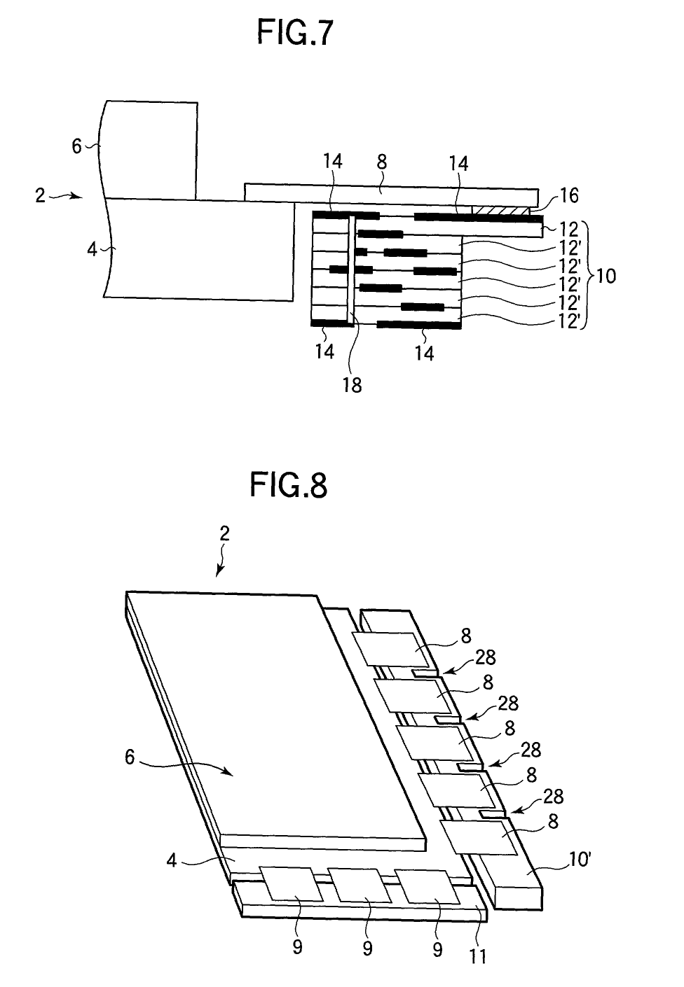

Next, modified peripheral circuit boards 10 for the LCD according to the embodiment will be described with reference to FIGS. 6 and 7. FIG. 6 is a sectional view illustrating a modified peripheral circuit board 10 for the LCD according to the embodiment. As shown in FIG. 6, this modified example has a feature in that the wiring pattern 14 is formed on the surface of the board only in the connection region A, but no wiring pattern 14 is formed on the layers other than the board exposed to the surface. FIG. 7 is a sectional view illustrating a further modified peripheral circuit board 10 for the LCD according to the embodiment. As shown in FIG. 7, this modified example has a feature in that the connection region A is formed by only a piece of the uppermost printed board 12 having the wiring pattern 14 formed on the surface thereof.

The above two modified examples exhibit the same effects as those of the above-mentioned embodiment but having the wiring pattern 14 formed on only the surface of the board in the connection region A. Therefore, the surface of the connection region A does not become rugged that was caused by the presence of the wiring pattern 14. Therefore, the peripheral circuit board 10 for the LCD and the flexible circuit boards 8 are uniformly adhered by the application of heat and pressure, and the connection does not become defective. Further, the wiring pattern 14 is formed on only the surface of the board in the connection region A and, hence, the temperature is uniformly distributed on the surface of the connection region A at the time of adhesion by the application of heat and pressure. Therefore, no defective connection occurs despite the adhesion is effected with heat and pressure by using the ACF 16 or the solder or the like.

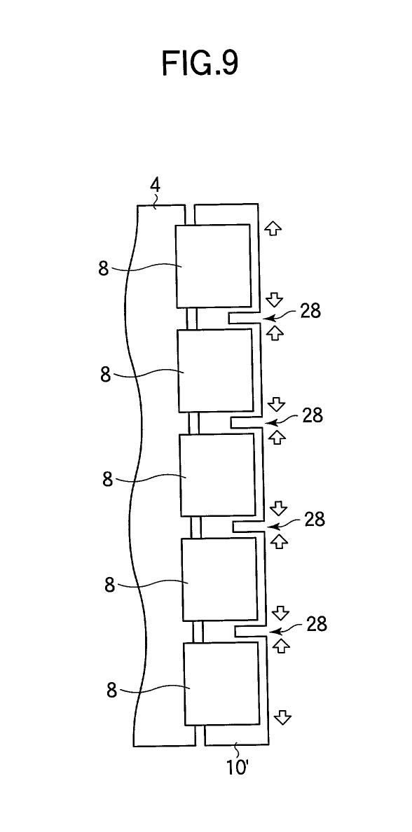

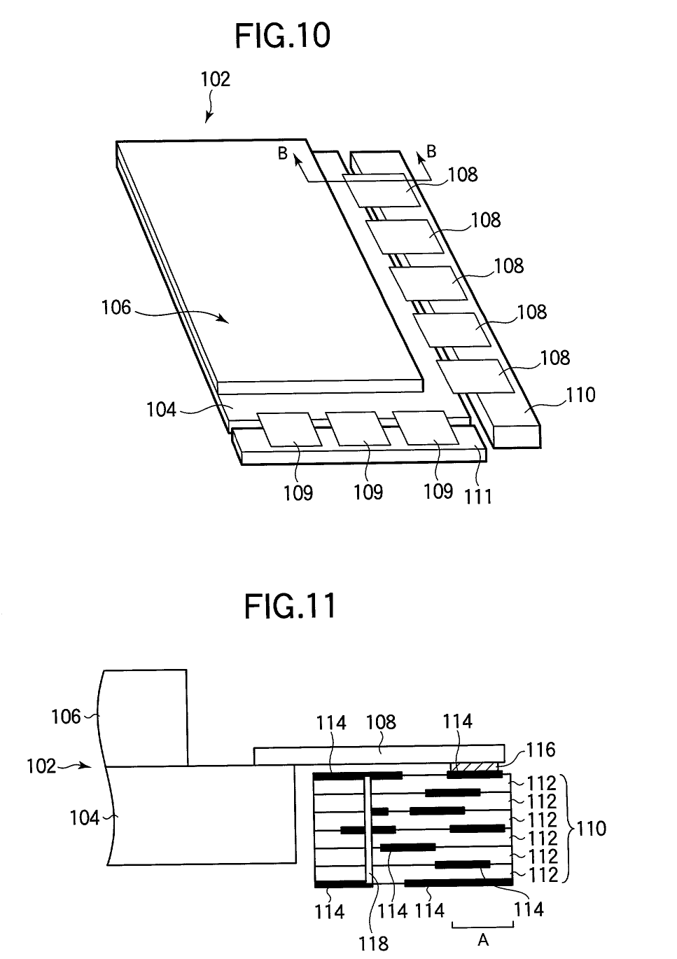

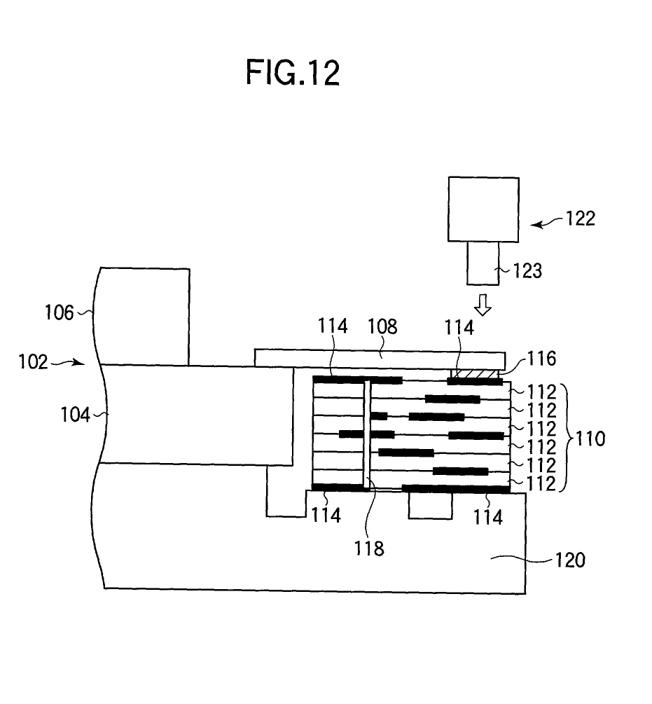

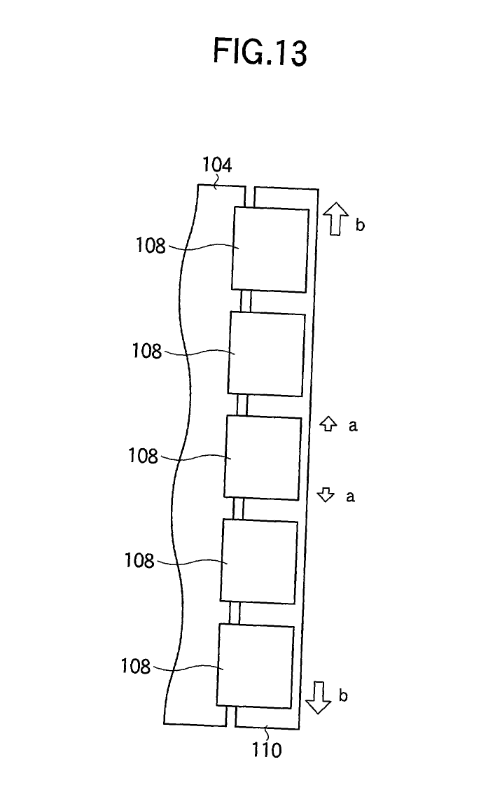

Next, the peripheral circuit board for the LCD and the LCD equipped therewith according to a second embodiment of the invention will be described with reference to FIGS. 8 and 9. FIG. 8 is a perspective view schematically illustrating the constitutions of the peripheral circuit board 10′ for the LCD and of the LCD equipped therewith according to this embodiment. The constituent elements having the same functions and actions as those of the first embodiment shown in FIG. 1 are denoted by the same reference numerals but their description is not repeated.

The peripheral circuit board 10′ for the LCD according to this embodiment is formed by laminating a plurality of printed boards 12 having nearly the same shape, and has slits 28 formed in the connection region A thereof. The slits 28 are formed by notches and divide the connection region A into a plurality of portions in the region. FIG. 9 is a plan view illustrating the constitution of the peripheral circuit board 10′ for the LCD according to this embodiment. The connection region A of the peripheral circuit board 10′ for the LCD has a plurality of terminal portions for connection to the flexible boards 8 separated by a plurality of (four in FIG. 9) slits 28. The slits 28 have a rectangular shape, the lengthwise direction thereof being at right angles with the lengthwise direction of the connection region A.

According to this embodiment, the connection region A of the peripheral circuit board 10′ for the LCD is divided into a plurality of portions by the slits 28. As indicated by arrows in FIG. 9, therefore, the stretching due to thermal expansion is absorbed by the slits 28. Hence, the amount of stretching of the intermediate portion is not accumulated at both ends of the peripheral circuit board 10′ for the LCD in the lengthwise direction. At the time of adhesion with the application of heat and pressure, therefore, the positions are deviated little between the peripheral circuit board 10′ for the LCD and the flexible circuit boards 8, and the connection is not broken between the terminals. Besides, since no stress due to the stretching of the peripheral circuit board 10 for the LCD is applied to the flexible circuit boards 8, no peeling occurs in the portions where the flexible circuit boards 8 and the peripheral circuit board 10 for the LCD are adhered together with the application of pressure.

This invention can be modified in a variety of other ways without being limited to the above embodiments only.

The above embodiments have dealt with the peripheral circuit boards 10, 10′ for the LCD for driving the drain bus lines. Not being limited thereto only, however, the invention can also be applied to the peripheral circuit board 11 for the LCD for driving the gate bus lines.

According to the above second embodiment, the peripheral circuit board 10′ for the LCD is constituted by laminating a plurality of printed boards 12 having nearly the same shape. The invention, however, is not limited thereto only. Like in the above-mentioned first embodiment, the connection region A may be formed of the printed boards 12 of a number of pieces smaller than that of other regions. Like in the above modified example of the first embodiment, further, the wiring pattern 14 maybe formed on only the surface of the board in the connection region A.

According to the above second embodiment, further, the connection region A of the peripheral circuit board 10′ for the LCD is separated for each of the terminal potions that are connected to the flexible boards 8. Not being limited thereto only, however, the connection region A may be separated for every plurality of terminal portions.

According to the above-mentioned embodiments, further, the connection regions A are formed in the peripheral circuit boards 10 and 11 for the LCD at the end portions on the side opposite to the end portions that are connected to the liquid crystal panel 2. Not being limited thereto only, however, the invention can also be applied to the peripheral circuit boards for the LCD having the connection regions A formed at the end portions on the side connected to the liquid crystal panel 2, as a matter of course. In this case, the connection region A may be formed of the printed boards 12 only without including the uppermost layer.

In the above-mentioned embodiments, the invention is applied to the LCD. However, the invention is not limited to the above-mentioned embodiments. The invention can be applied to flat-panel display devices like a PDP or an EL (electro-luminescence) display which has a structure to connect the panel substrate and the peripheral circuit substrate with FPC or the like.

As described above, this invention improves reliability in the connection between the peripheral circuit boards for the LCD and the flexible circuit boards.

What is claimed is:

1. A peripheral circuit board for a display device, comprising:
a connection region formed in a laminated layer structure of a plurality of printed boards having predetermined wiring patterns, the connection region being formed by the printed boards of a number of pieces smaller than that of other regions; and
a plurality of terminal portions formed on the surface of the connection region and are electrically connected to a display panel through a plurality of flexible circuit boards.

2. A peripheral circuit board for a display device according to claim 1, wherein the connection region has the wiring pattern on the surface only.

3. A peripheral circuit board for a display device according to claim 1, wherein the connection region is formed by only a piece of the printed board.

4. A peripheral circuit board for a display device according to claim 3, wherein the connection region is formed by the printed board of the uppermost layer.

5. A peripheral circuit board for a display device according to claim 1, wherein the connection region is formed at an end on the side opposite to the end of the side that is connected to the display panel.

6. A peripheral circuit board for a display device according to claim 1, wherein the connection region has slits formed therein.

7. A peripheral circuit board for a display device according to claim 6, wherein the slits are so formed that the lengthwise direction thereof is at right angles with the lengthwise direction of the connection region.

8. A peripheral circuit board for a display device according to claim 6, wherein the connection region is separated for each of the terminal portions.

9. A peripheral circuit board for a display device, comprising:
a connection region formed in a laminated layer structure of a plurality of printed boards having predetermined wiring patterns, the connection region being formed by the printed boards of a number of pieces smaller than that of other regions and being divided by slits into a plurality of portions in the region; and
a plurality of terminal portions formed on the surface of the connection region and are electrically connected to a display panel through a plurality of flexible circuit boards.

10. A peripheral circuit board for a display device according to claim 9, wherein the slits are so formed that the lengthwise direction thereof is at right angles with the lengthwise direction of the connection region.

11. A peripheral circuit board for a display device according to claim 9, wherein the connection region is separated for each of the terminal portions.

12. A display device comprising:
a display panel having a pair of boards arranged being opposed to each other; and
peripheral circuit boards for a display device connected to the boards via flexible circuit boards;
wherein the peripheral circuit boards for the display device of any one of claims 1 to 11 are used as the peripheral circuit boards for the display device.
